(19) United States
(12) Patent Application Publication
(10) Pub. No.: US 2005/0140663 A1
(43) Pub. Date: Jun. 30, 2005

(54) Ultrasonic electronic stylus and stylus-input system

(75) Inventor: Hisakazu Nakamura, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/010,413

(22) Filed: Dec. 14, 2004

(30) Foreign Application Priority Data
Dec. 15, 2003 (JP) 2003-417042

(51) Int. Cl. G09G 5/00

(52) U.S. Cl. 345/179

(57) ABSTRACT

An ultrasonic electronic stylus includes at least (i) an ultrasound element for generating ultrasound, (ii) tool force measuring means for measuring a tool force applied to a writing-tip, (iii) a control circuit substrate for controlling the ultrasound element and the tool force measuring means. The ultrasound element, the tool force measuring means, and the control means are arranged in this order from a front-end side on which inputting of data is carried out. Since the ultrasound emitted from the ultrasound element is not blocked by anything, the ultrasound is efficiently transmitted.

This Nonprovisional application claims priority under 35 U.S.C. § 119(a) on patent application Ser. No. 2003/417042 filed in Japan on Dec. 15, 2003, the entire contents of which are hereby incorporated by reference.

### FIELD OF THE INVENTION

The present invention relates to an ultrasound transmitting type electronic stylus (ultrasonic electronic stylus) and a stylus-input system including the ultrasonic electronic stylus. More specifically, the present invention relates to the ultrasonic stylus which is capable of efficiently transmitting ultrasound, and the stylus-input system including the ultrasound electronic stylus, the stylus-input system (a) allowing, in a position determining method, especially in a method in which drawing/writing is performed directly on an electronic display device, an ultrasound input operation that causes no deterioration in display of the electric display device, (b) having small size, light weight, low power consumption, and low cost, and (c) having both functions of performing position determining and tool force measurement.

### BACKGROUND OF THE INVENTION

Lap top computers (PCs) in recent years have been becoming lighter and lighter, and have been applied to wider variety of mobile applications. Some of these laptop PCs in the market weighs even less than 1 kg. Meanwhile, there is an increasing needs of an input system in which an electronic stylus is used for inputting data to a system such as a PC whose weight is further reduced. Such an inputting system in which the electronic stylus is used is hereinafter referred to as stylus-input system. Recently, in the stylus-input system, there has been a growing call for an impression of using an actual notebook, i.e. an impression of actually writing on a piece of paper, just like what is meant by the name “stylus-input system”.

Under the circumstances, the electronic stylus has been also developed. In a case where the electronic stylus is used, electronic data is obtained from, for example, an image or a character drawn/written on actual paper with the electronic stylus, and developments have been made actively on an input operation of the electronic stylus, and a system utilizing the electronic stylus. In the market recently traded is, for example, the electronic stylus utilizing ultrasound (ultrasonic electronic stylus) such as mimio (registered trademark) produced by KOKUYO Co., Ltd., and pc notetaker (registered trademark) produced by Pegasus Technology Ltd. Further, the development is also carried out with respect to the ultrasonic electronic stylus that is capable of accurately inputting the image or the character drawn/written on a desk, without using a piece of paper or a board specially designed for the electronic stylus.

In order to carry out input using the ultrasound electronic stylus just like drawing/writing on the paper, a feel of input reflecting a tool force is necessary. Namely, it is required that the stylus-input system be capable of adjusting thickness and brightness of an inputted line by measuring the tool force. Accordingly, the ultrasonic electronic stylus is provided with a system (tool force measuring mechanism) and a sensor respectively for sensing changes in the tool force applied to the ultrasonic electronic stylus.

As described, the ultrasonic electronic stylus must be provided with an ultrasound element for generating the ultrasound and the tool force measuring mechanism.

In the ultrasonic electronic stylus, ultrasound transmitting schemes includes: (i) side-surface ultrasound transmitting scheme in which the ultrasound is transmitted via a side surface of an enclosure of the ultrasonic electronic stylus, or (ii) front-end ultrasound transmitting scheme in which the ultrasound is transmitted from a front end of the enclosure. As shown in FIG. 9, in an ultrasonic electronic stylus 20 adopting the side-surface ultrasound transmitting scheme, the ultrasound is generated by an ultrasound element 24, and then transmitted from an ultrasound transmitting section 22 formed on the side-surface of an enclosure 23. On the contrary, as shown in FIG. 10, in an ultrasonic electronic stylus 30 adopting the front-end ultrasound transmitting scheme, the ultrasound is generated by an ultrasound element 34, and then transmitted from an ultrasound transmitting section 32 at a front-end of an enclosure 33.

Almost any writing tools, including the ultrasonic electronic stylus, are tilted while being used. Tilting the ultrasonic electronic styluses 20 and 30 causes differences between the positions of pointing ends, i.e. writing-tips 21 and 31 and positions determined based on sets of positional information (Hereinafter referred to as positional differences). Consequently, the positions of the writing-tips are inaccurately determined. For this reason, the ultrasonic electronic stylus 30 adopting the front-end ultrasound transmitting scheme is selected in many cases, over the ultrasonic electronic stylus 20 adopting the side-surface ultrasound transmitting scheme, in order to minimize the amount of positional differences.

As for the tool force measuring mechanism which is necessary in the ultrasonic electronic stylus, for example, Japanese Unexamined Patent Publication No. 3-286326/1991 (Tokukaihei 3-286326; published on Dec. 17, 1991; hereinafter referred to as patent document 1) discloses a tool force measuring mechanism which is a combination of a permanent magnet and a magnetoresistive element. More specifically, in the tool force measuring mechanism, the magnet and the magnetoresistive element come closer to each other or get farther from each other in accordance with the tool force applied to a leading edge, as such, the distance between the magnet and the magnetoresistive element varies in accordance with the tool force applied. Accordingly, by measuring detecting magnetic field around the permanent magnet, it is possible to measure the tool force being applied.

However, though the patent document 1 discloses the tool force measuring mechanism, a stylus and its arrangement adopting ultrasound scheme are not at all mentioned. Further, it is necessary that the ultrasonic electronic stylus be provided with a position determining mechanism for determining the position of the ultrasonic electronic stylus (i.e. the position of the writing-tip). However, this position determining mechanism is not mentioned anywhere in the patent document 1 either.

Incidentally, it is preferable that the writing-tip be provided in a vicinity of the tool force measuring mechanism, so that the tool force is accurately measured. However, if arranging the writing-tip and the tool force measuring mechanism close to each other, the ultrasound element is positioned at a back of the tool force measuring mechanism (i.e. on a far-side from the writing tip). In short, the tool force measuring mechanism is positioned between the writing-tip and the ultrasound element. As such, in the ultrasonic electronic stylus, the writing-tip, the tool force measuring mechanism, the ultrasound element, and a control section are arranged in this order from the leading end of the writing tip.

In the foregoing arrangement, however, since the tool force measuring mechanism is positioned between the writing-tip and the ultrasound element, the tool force measuring mechanism disturbs the ultrasound emitted from the ultrasound element. This results in inefficient transmission of the ultrasound.

As described, it is important, particularly in the front-end ultrasound transmitting scheme, how appropriately an ultrasound transmitting device and the tool force measuring mechanism are arranged for realizing an efficient ultrasound transmission. Further, it is also important to arrange the ultrasound transmitting device and the tool force measuring mechanism, taking into account a size of the ultrasonic electronic stylus, in order to realize the ultrasonic electronic stylus for use in the mobile applications.

Further in the stylus-input system utilizing the ultrasonic electronic stylus, it is necessary that the ultrasonic electronic stylus be provided with the position determining mechanism for determining the position of the ultrasonic electronic stylus by continuously tracing a movement of the ultrasonic electronic stylus. With this position determining mechanism, it becomes possible to accurately recognize information, such as a character or an image, inputted by the ultrasonic electronic stylus.

### SUMMARY OF THE INVENTION

In view of the foregoing problems, the present invention was made and it is an object of the present invention to provide (i) an ultrasonic electronic stylus that is capable of efficiently transmitting ultrasound and yet causes no deterioration in tool force sensitivity, and (ii) a stylus-input system using the ultrasonic electronic stylus.

In order to achieve the foregoing objects, an ultrasonic electronic stylus in accordance with the present invention includes (a) an ultrasound element for generating ultrasound; (b) tool force measuring means for measuring a tool force applied in stylus input operation; and (c) control means for controlling the ultrasound element and the tool force measuring means, the ultrasound element, the tool force measuring means, and the control means being arranged in this order from a side of a front end of the ultrasonic electronic stylus where stylus input is carried out, toward a side of a rear end thereof.

Since a conventional ultrasonic electronic stylus was designed, focusing on the measurement of the tool force applied, the tool force measuring means, the ultrasound element, and the control means are arranged in this order from a front-end side on which data input is carried out. Therefore, it has been difficult to transmit the ultrasound efficiently since the tool force measuring means partially blocks the ultrasound emitted from the ultrasound element.

On the contrary, in the arrangement of the foregoing ultrasonic electronic stylus according to the present invention, the ultrasound emitted from the ultrasound element is not blocked by the tool force measuring means. Thus, it is possible to efficiently transmit the ultrasound.

Further, in order to achieve the foregoing objects, an ultrasonic electronic stylus in accordance with the present invention includes an enclosure including: (a) an ultrasound element for generating ultrasound, the ultrasound element moving in the enclosure in accordance with a tool force applied in stylus input operation; (b) tool force measuring means having at least a magnet and a magnetoresistive element whose electric resistance varies in accordance with a change in magnetic field of the magnet, the magnet or the magnetoresistive element being fixed to the ultrasound element; and (c) control means for controlling the ultrasound element and the tool force measuring means, the ultrasound element, the tool force measuring means, and the control means being arranged in this order from a front-end side of the enclosure toward a rear-end side of the enclosure.

In the foregoing arrangement, the ultrasound element is closer to the front-end side of the enclosure than the tool measuring means is. Therefore, the ultrasound emitted from the ultrasound element is not blocked by the tool force measuring means. This enables the ultrasound to be efficiently transmitted.

In order to achieve the foregoing objects, a stylus-input system in accordance with the present invention includes (i) an ultrasonic electronic stylus including at least (a) an ultrasound element for generating ultrasound; (b) tool force measuring means for measuring a tool force applied in stylus input operation; and (c) control means for controlling the ultrasound element and the tool force measuring means, the ultrasound element, the tool force measuring means, and the control means being arranged in this order from a side of a front end of the ultrasonic electronic stylus where stylus input is carried out, toward a side of a rear end thereof; and (ii) receiving means for receiving the ultrasound transmitted from the ultrasound electronic stylus.

With the foregoing stylus-input system, it is possible to (i) efficiently emit the ultrasound from the ultrasonic electronic stylus, and (ii) accurately specify a position of the ultrasonic electronic stylus. This realizes the stylus-input system in which electronic data processed therein accurately reflects information inputted with the ultrasonic electronic stylus.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a plane view showing a main part of an ultrasonic electronic stylus in accordance with the present invention.

FIG. 2 is a perspective view showing an arrangement of an enclosure of the ultrasonic electronic stylus shown in FIG. 1.

FIG. 3 is a perspective view illustrating an ultrasound element and a writing-tip of the ultrasonic electronic stylus shown in FIG. 1.

FIG. 4 is a perspective view showing another arrangement of the enclosure of the ultrasonic electronic stylus shown in FIG. 1.

FIG. 5 is a plane view showing an overall structure of the ultrasonic electronic stylus having the arrangement shown in FIG. 4.

FIG. 6 is a graph showing a comparison on intensity of ultrasound transmitted between the ultrasonic electronic stylus of the present invention and the conventional ultrasonic electronic stylus.

FIG. 7 is a graph showing a comparison on positional differences in the ultrasonic electronic stylus and the positional differences in the position of the conventional ultrasonic electronic stylus.

FIG. 8 is a block diagram showing a device for measuring the intensity of the ultrasound shown in FIG. 6.

FIG. 9 is a plane view showing an arrangement of the conventional ultrasonic electronic stylus.

FIG. 10 is a plane view showing an arrangement of another conventional ultrasonic electronic stylus.

FIG. 11 is a perspective view showing a main part of a stylus-input system of the present invention in which the ultrasonic electronic stylus of the present invention is utilized.

### DESCRIPTION OF THE EMBODIMENTS

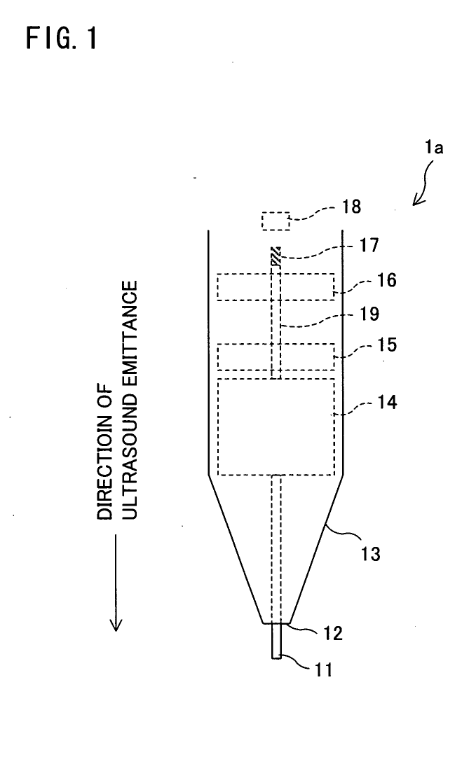

The following describes an embodiment of the present invention with reference to FIGS. 1 through 8, and FIG. 11. Note that the present invention is not limited to the following.

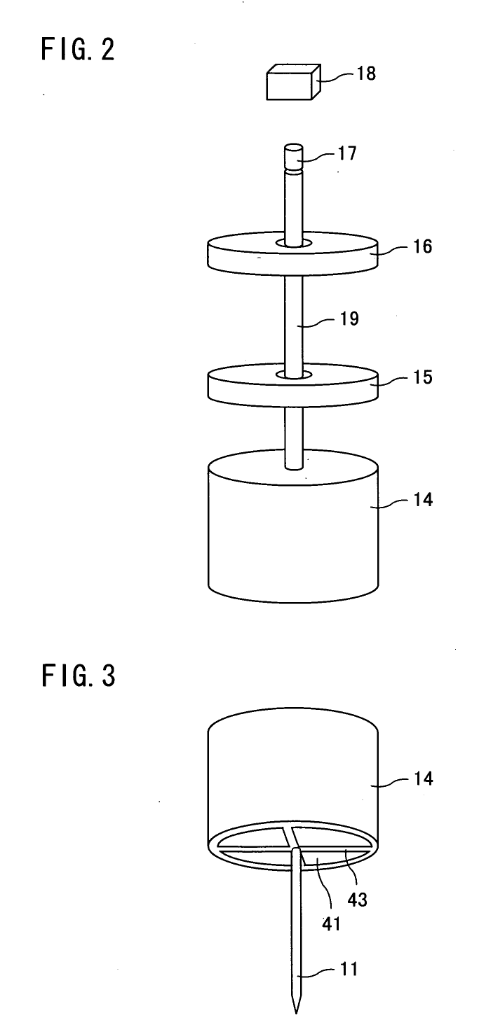

FIG. 1 and FIG. 2 are diagrams showing a main part of an ultrasonic electronic stylus 1a in accordance with the present embodiment. As shown in these FIG. 1 and FIG. 2, the ultrasonic electronic stylus 1a includes an enclosure 13 in which an ultrasound element 14, supporting members 15 and 16, a magnet 17, a magnetoresistive element (Hereinafter referred to as MR element) 18, and a supporting rod 19, are respectively provided in this order from a writing-tip 11 side of the enclosure 13. In the ultrasonic electronic stylus 1a, a stylus-input side of the enclosure 13, i.e. a side on which the writing-tip is provided, is hereinafter referred to as a front end, and a side opposite to the front end is referred to as a rear end.

Positional relationship of respective members of the ultrasonic electronic stylus 1a is as follows. The writing-tip 11 for carrying out stylus input operation is provided in the center of the ultrasonic electronic stylus 1a on the front end side of the enclosure 13 with respect to the ultrasound element 14. Further, the supporting rod 19 for supporting the ultrasound element 14 is provided in the center of the ultrasonic electronic stylus 1a on the rear end side of the enclosure 13 with respect to the ultrasound element 14. Accordingly, the writing tip 11 and the supporting rod 19 are arranged in a substantially straight line so as to align with a central axis extended in a lengthwise direction of the enclosure 13.

The ultrasound element 14 is one for generating ultrasound. In FIGS. 1 and 2, the ultrasound element 14 is of a substantially cylindrical or disc shape. This ultrasound element 14 generates the ultrasound from a bottom surface thereof, and that the writing tip 11 is fixed on the bottom surface on which the ultrasound is generated (ultrasound emitting surface).

The ultrasound element 14 is not limited as long as it generates ultrasound. Examples of the ultrasound element 14 includes a piezoelectric element made of a piezoelectric material such as single crystal, ceramic, thin film, polymeric material, or a compound of these materials. The ultrasound element 14 is preferably the piezoelectric element made of piezoelectric ceramic, particularly, lead zirconate titanate (so-called PZT-piezoelectric element, hereinafter referred to as PZT element). The PZT element outputs a large sound (sound pressure) with respect to an inputted voltage, as such, it does not require a high voltage to input. This realizes a small scale power source circuit which is to be mounted in a stylus, thus contributing size reduction of the stylus. Further, the PZT element, a ceramic-based element, is mechanically and environmentally more reliable than a film-based element.

It should be noted that the ultrasound element 14 is not limited to the piezoelectric element made of lead zirconate titanate or the like. For example, it is possible to adopt PVDF (polyvinylidene difluoride) to the ultrasound element 14. However, since PVDF outputs much less sound than PZT element, the power source circuit becomes very large in size.

One end of the supporting rod 19 is attached to the ultrasound element 14, and another end of the supporting rod 19 is attached to the magnet 17 for measuring tool force. More specifically, the supporting rod 19 is fixed to the ultrasound element 14 on a surface opposite to the ultrasound emitting surface where the ultrasound element 11 is provided, and is supported by the two supporting members 15 and 16 respectively provided substantially perpendicular to the supporting rod 19 (i.e. substantially perpendicular to the lengthwise direction of the enclosure 13). The supporting members 15 and 16 are fixed at fixing sections (not shown) provided in the enclosure 13. It should be noted that the supporting members 15 and 16 are doughnut-shaped, each having a hole in the center thereof. The supporting rod 19 is movably disposed through the holes on the supporting members 15 and 16. Therefore, the supporting rod 19 is movable in the lengthwise direction of the enclosure 13 in accordance with the tool force applied to the writing tip 11.

In an ultrasonic electric stylus 1a, for measurement of the tool force, the magnet 17 tool force is provided at the rear end of the supporting rod 19, and the MR element 18 is provided apart from the supporting rod 19 at an arbitrary distance from the magnet 17. In other words, the MR element 18 is provided on a line extending from the rear end of the supporting rod 19 (in the vicinity of the magnet 17) at the arbitrary distance from the magnet 17. As described above, the supporting rod 19 is movable in the lengthwise direction of the enclosure 13 in accordance with the tool force applied to the writing-tip 11, as such, the magnet 17 and the MR element 18 come closer to each other and get far from each other in accordance with the tool force applied. In short, a distance between the magnet 17 and the MR element 18 varies depending on the tool force being applied. Therefore, it is possible to obtain tool force information, by determining out properties of the MR element 18 which measures a magnetic force strength of the magnet 17 varying depending on the distance between the magnet 17 and the MR element 18. Thus, in the ultrasonic electronic stylus 1a, the magnet 17, the MR element 18, and the movable supporting rod 19 are provided in a tool force measuring mechanism.

Note that, the magnet 17 and the MR element 18 are arranged so as to come closer to each other and get far from each other in accordance with the tool force tool force applied. In other words, a relative distance between the magnet 17 and the MR element 18 varies in accordance with the tool force tool force being applied. As shown in FIG. 1 for example, the magnet 17 is provided at the rear end of the supporting rod 19, and the tool force is measured using the magnet 17 and the MR element 18 getting closer or getting farther in accordance with the tool force being applied, therefore the magnet 17 and the MR element 18 may be so arranged that the distance therebetween relatively varies in accordance with the tool force being applied.

As described, the ultrasonic electronic stylus 1a of the present embodiment includes the tool force measuring mechanism (tool force measuring means) in which at least the magnet 17 and the MR element 18 are provided such that the distance between the magnet 17 and the MR element 18 varies in accordance with the tool force applied. In this embodiment, the MR element 18 is fixed, and it is the magnet 17 that gets closer to the MR element 18 or gets far from the MR element 18. However, the present invention is not limited to this, as long as the magnet 17 and the MR element 18 are so arranged that the distance between the magnet 17 and the MR element 18 relatively varies in accordance with the tool force being applied.

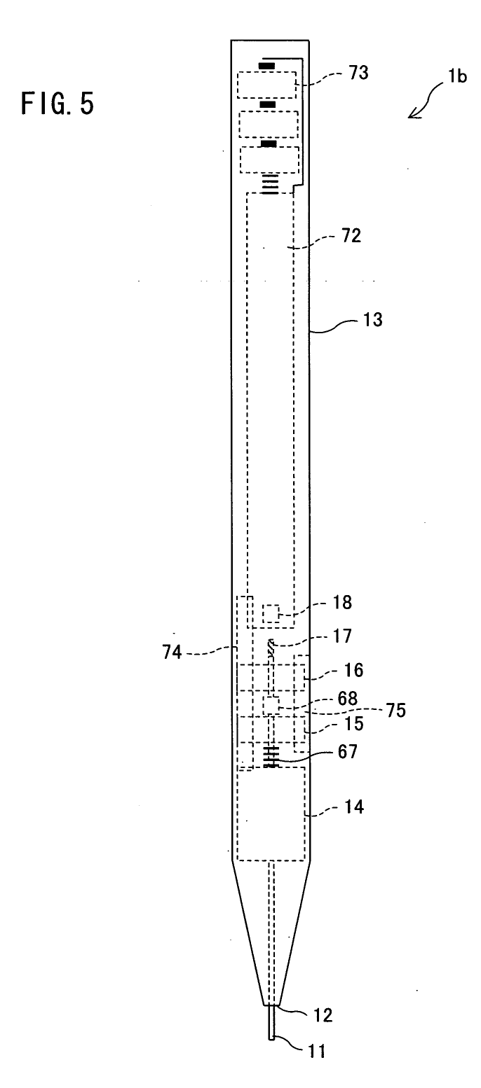

It should be noted that the enclosure 13 includes a control circuit substrate (control means) (not shown in FIGS. 1 and 2.) provided on the rear end side with respect to the MR element 18. This control circuit substrate is one for controlling the ultrasound element 14 and the tool force measuring mechanism in accordance with control signals. Details of the control circuit substrate are described later with reference to FIG. 5. Note that the control circuit substrate is so arranged that the control circuit does not negatively affect ultrasound emittance or performance of the tool force measuring mechanism.

As described, in the ultrasonic electronic stylus 1a, the writing-tip 11 is provided on the front end side with respect to the ultrasound element 14, and the magnet 17 is provided on the rear end side with respect to the ultrasound element 14. More specifically, the ultrasound element 14, the tool force measuring mechanism, and the control circuit substrate are provided in this order from the writing-tip 11 side, i.e. from the front end side of the ultrasonic electronic stylus 1a.

In this arrangement, the ultrasound element 14 and an ultrasound transmitting section 12 have nothing therebetween, so that the ultrasound generated from the ultrasound element 14 is not blocked. This allows the ultrasound generated from the ultrasound element 14 to be efficiently transmitted from the ultrasound transmitting section 12.

Since the conventional ultrasonic electronic stylus was designed, focusing on the measurement of the tool force applied, the tool force measuring mechanism is provided in the vicinity of the writing-tip. That is to say the tool force measuring means is provided between the writing-tip and the ultrasound element. Therefore, it is difficult to transmit the ultrasound efficiently since the tool force measuring means partially blocks the ultrasound emitted from the ultrasound element.

On the contrary, in the ultrasonic electronic stylus 1a of the present embodiment, between the ultrasound element 14 and the ultrasound transmitting section 12, there is nothing to block the ultrasound being emitted from the ultrasound element 14. Therefore, it is possible to efficiently emit the ultrasound generated from the ultrasound element 14.

Next, characteristics of the respective members in the foregoing arrangement are described in detail. First, described are the writing-tip 11, the ultrasound transmitting section 12, and the ultrasound element 14.

FIG. 3 shows the writing tip 11 and the ultrasound element 14. As shown in FIG. 3, the ultrasound element 14 is provided with an opening section 41 on the bottom surface on the ultrasound emitting side. The ultrasound generated in the ultrasound element 14 is emitted from the opening section 41, and then transmitted via the ultrasound transmitting section 12 on the front end of the enclosure 13.

In the opening section 41, a writing-tip holding member 43 is formed in the shape of a cross. The writing-tip 11 is fixed at the intersection of two square bars of the writing-tip holding member 43 (in the center of the writing-tip holding member 43).

In the present embodiment, the writing-tip holding member 43 is made of polycarbonate. Each of the square bars forming the writing-tip holding member 43 is 1 mm in thickness and 1 mm in width. Further, the writing tip 11 is also made of polycarbonate, and the ultrasound element 14 is a piezoelectric element packed in a polycarbonate package.

It should be noted that, in FIG. 3, the writing-tip holding member 43 is formed of the square bars crossed each other with respect to the opening section 41. However, the shape and arrangement of writing-tip holding member 43 is not limited to this as long as the writing-tip 11 can be fixed on the ultrasound element 14. For example, the writing-tip holding member 43 may be formed of a single square bar, or be formed of three or more square bars. However, in order to efficiently emit the ultrasound from the ultrasound element 14, the opening section 41 preferably has a large area.

In view of strength and weight, polycarbonate is used as material for the writing-tip 11, the package for packaging the ultrasound element 14, and the writing-tip holding member 43. However, it is possible to use any kinds of materials other than polycarbonate, provided that they have an adequate strength for the movement within the enclosure 13 and the use of them do not result in the ultrasonic electronic stylus 1a that is not too heavy in weight since the above members move in the enclosure 13 in accordance with the tool force applied.

It should be noted that the ultrasound transmitting section 12 is preferably provided in the vicinity of the front end of the enclosure 13, i.e. in the vicinity of the writing-tip 11, so that a hand of a user holding the ultrasonic electronic stylus 1a does not block the ultrasound being transmitted. In short, it is preferable that the ultrasonic electronic stylus 1a adopts a front-end ultrasound transmitting scheme described in BACKGROUND OF THE INVENTION. With this arrangement, the ultrasound transmitting section 12 can more efficiently transmit the ultrasound being generated in the ultrasound element 14. Further, since a leading edge of the writing-tip 11 and the ultrasound transmitting section 12 are close to each other, a difference in determining a position of the writing-tip 11 is avoided even in a case where the ultrasonic electronic stylus 1a is tilted while being used. Therefore, it is possible to accurately measure the position of the writing-tip 11.

Next, the tool force measuring mechanism in the ultrasonic electronic stylus 1a is described. In the present embodiment, the tool force applied to the writing-tip 11 is measured based on the distance between the magnet 17 and the MR element 18. More specifically, in the ultrasonic electronic stylus 1a, the writing-tip 11, the ultrasound element 14, and the supporting rod 19 can move in the lengthwise direction (upward and downward) of the enclosure 13, in accordance with the tool force applied to the writing-tip 11. Accordingly, when the tool force is high, the writing-tip 11 is pushed into the enclosure 13, thus causing the supporting rod 19 to move toward the MR element 18. Therefore, the magnet 17 and the MR element 18 become close to each other. On the contrary, when the tool force is low, a pushed length of the writing-tip 11 into the enclosure 13 decreases, resulting in the distance of the supporting rod 19 from the MR element 18 to be longer than when the large tool force is applied. Therefore, the magnet 17 and the MR element 18 get far from each other.

The magnetic field applied from the magnet 17 to the MR element 18 varies with change of the distance between the magnet 17 and the MR element 18. An electric resistance of the MR element 18 changes proportionally with the strength of a magnetic field externally applied thereto. This enables measurement of the tool force based on the distance between the magnet 17 and the MR element 18.

As described, the tool force measuring mechanism in the ultrasonic electronic stylus 1a is made up of the magnet 17, the MR element 18, and the supporting rod 19. In this arrangement, the distance between the magnet 17 and the MR element 18 varies in accordance with the tool force applied, as such, the magnetic force applied from the magnet 17 to the MR element 18 varies in accordance with the distance (i.e. in accordance with the tool force). As a result, the tool force can be measured based on a change in the electric resistance of the MR element 18 caused by changes in the distance between the magnet 17 and the MR element 18. As a result, it is possible to obtain tool force information, a change in the electric resistance of the MR element 18 caused by the changes in the distance between the magnet 17 and the MR element 18.

In the ultrasonic electronic stylus 1a of the present embodiment, the tool force measuring mechanism is provided with the supporting rod 19 of 30 mm in length and 2 mm in diameter. Further, the supporting members 15 and 16 for supporting the supporting rod 19 are respectively formed in the doughnut-like disc shape, and are respectively fixed in the enclosure 13. Each of the supporting members 15 and 16 have, in each of center portions thereof, the hole in which the supporting rod 19 can smoothly move. Further, the magnet 17 is permanent magnet of 5 mm in length and 2 mm in diameter. The MR element 18 is EZMPL20H produced by Matsushita Electric Industrial Co., Ltd.

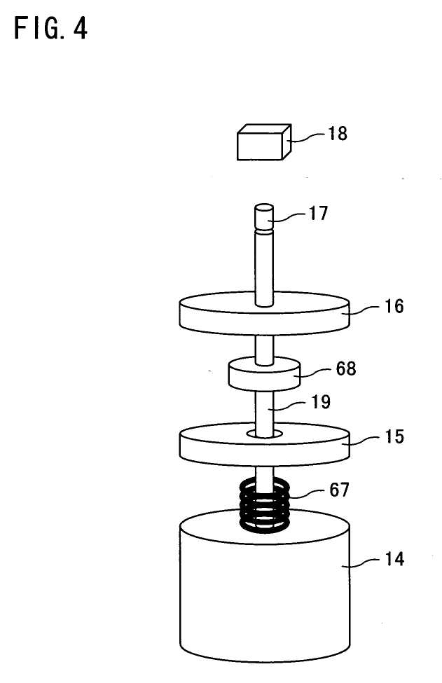

It should be noted that the tool force measuring mechanism shown in FIG. 2 is preferably provided with a spring 67 (expanding-and-contracting means) and a stopper 68 (contact preventing means) as shown in FIG. 4, so that the ultrasonic electronic stylus can be used just like writing with an actual pen. More specifically, the spring 67 is expandable and contractible in accordance with the tool force applied. When the tool force is high, the spring 67 contracts, thereby causing the magnet 17 and the MR element 18 to be close to each other. Then when the tool force is low, the spring 67 expands, thereby causing the magnet 17 and the MR element 18 to be far from each other. As described, the tool force is accurately reflected with a provision of the spring 67, thus realizing using the ultrasonic electronic stylus for input in a similar way the actual pen is used. Note that a feeling of the stylus-input can be changed by using a different spring 67.

The stopper 68 is provided between the supporting members 15 and 16, and is fixed onto the supporting rod 19. With this arrangement, when the supporting rod 19 moves toward the MR element 18 by application of a high tool force, the stopper 68 cannot move towards the rear end of the ultrasonic electronic stylus 1a beyond the supporting member 16. In short the stopper 68 and the supporting member 16 regulate movement of the supporting rod 19. Accordingly, even if a significantly high tool force is applied, it is possible to prevent the magnet 17 from coming into contact with the MR element 18 without fail.

The following describes differences in functions between the ultrasonic electronic stylus of the present invention and the conventional ultrasonic electronic stylus. More specifically, comparison on intensity of ultrasound transmitted is made between the ultrasonic electronic stylus 1b of the present invention adopting the front-end ultrasound transmitting scheme the conventional ultrasonic electronic stylus adopting the side-surface ultrasound transmitting scheme. From the front end side of the ultrasonic electronic stylus 1b, the ultrasound element 14, the tool force measuring mechanism, the control circuit substrate 72 are arranged in this order. On the contrary, from the front end side of the conventional ultrasonic electronic stylus, the tool force measuring mechanism, the ultrasound element, and the control circuit substrate are arranged in this order.

It should be noted that the ultrasonic electronic stylus 1b includes the arrangement shown in FIG. 4 in the enclosure 13, and further includes, in the enclosure 13, (i) the control circuit substrate 72 for controlling the ultrasound element 14 and the tool force measuring mechanism and (ii) a battery 73 serving as a driving power source (see FIG. 5). Note further that the MR element 18 is mounted on the control circuit substrate 72, and the ultrasound element 14 is connected with the control circuit substrate 72 via a FPC (Flexible Printed Circuit). The battery 73 contained in the enclosure 13 is positioned on the back of the control circuit substrate 72 (at the rear end of the enclosure 13).

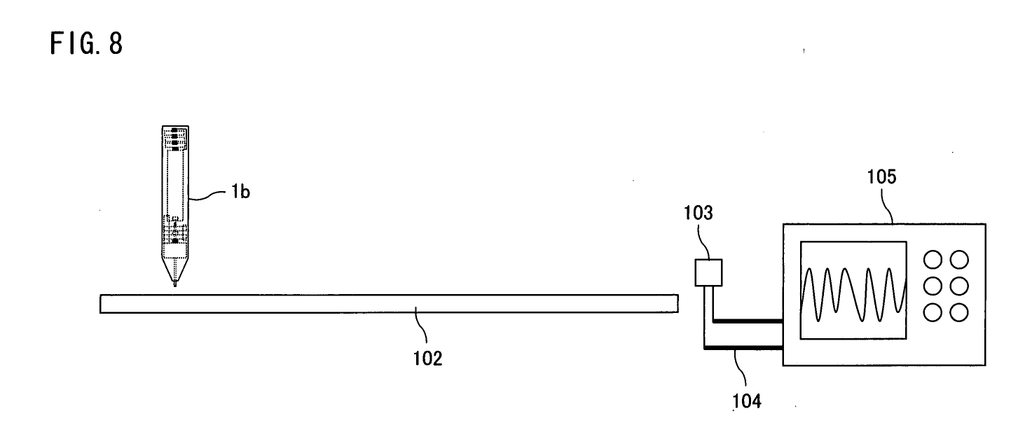

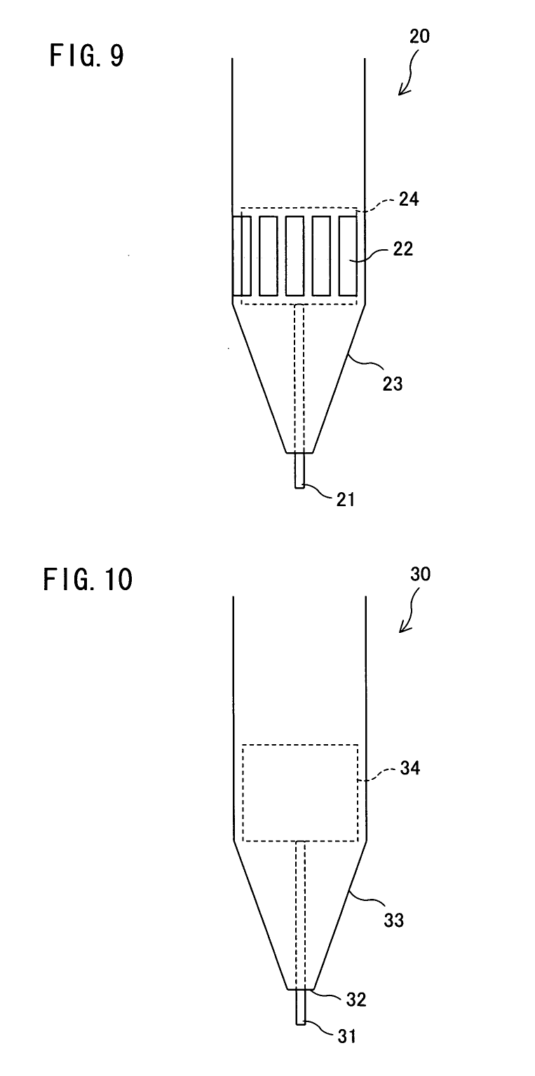

Further, intensity of the ultrasound transmitted from the respective ultrasonic electronic styluses was measured by a measuring system shown in FIG. 8. More specifically, as shown in FIG. 8, an ultrasound receiving device 103 which was set at an arbitrary distance from was used for receiving the ultrasound transmitted from the respective ultrasonic electronic styluses on a display section 102 of a personal computer. The ultrasound receiving device 103 includes an ultrasound receiving element and a sound-pressure-to-voltage converting element. The sound pressure of the ultrasound received by the ultrasound receiving element is converted into a voltage by the sound-pressure-to-voltage converting element in the ultrasound receiving device 103. The voltage is read by an oscilloscope 105 via a probe 104. A longer distance between the ultrasonic electronic stylus and the ultrasound receiving device 103 causes a lower intensity of the ultrasound received by the ultrasound receiving device 103, and the voltage read by the oscilloscope 105 becomes low as such.

In other words, with the measuring system shown in FIG. 8, it is possible to obtain the distance between the ultrasonic electronic stylus and the ultrasound receiving device 103, i.e. a positional information of the ultrasonic electronic stylus on the display section 102.

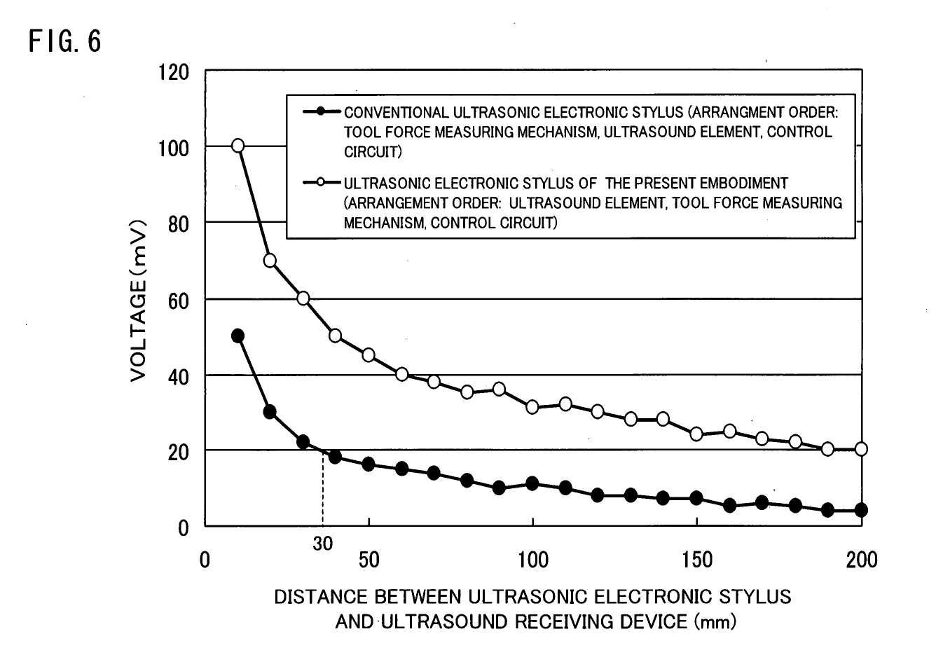

FIG. 6 is a graph showing the result of a comparison on the intensity of the ultrasound transmitted, measured by using the measuring system shown in FIG. 8. In FIG. 6, a horizontal axis is the distance between the ultrasonic electronic stylus and the ultrasound receiving device 103, and the vertical axis is the voltage read by the oscilloscope 105. As descried above, the voltage corresponds to the intensity of the ultrasound from the ultrasonic electronic stylus, received by the ultrasound receiving device 103.

As shown in FIG. 6, the intensity of the ultrasound transmitted from the ultrasonic electronic stylus 1b is higher than that of the ultrasound transmitted from the conventional ultrasonic electronic stylus. In the conventional ultrasonic electronic stylus, the tool force measuring mechanism is provided on the front end side of the ultrasonic electronic stylus with respect to the ultrasound element. Therefore, the tool force measuring mechanism disturbs the ultrasound emittance. As a result, the ultrasound generated in the conventional ultrasonic electronic stylus is not transmitted efficiently. On the contrary, in the ultrasonic electronic stylus 1b of the present embodiment, the tool force measuring mechanism is provided on the rear end side with respect to the ultrasound element 14, of the ultrasonic electronic stylus 1b. Therefore, the tool force measuring mechanism does not disturb the ultrasound emittance. This enables the ultrasound to be efficiently transmitted from the ultrasonic electronic stylus 1b.

Described in the following is how the positional information is obtained by using, for example, the ultrasound receiving device 103 that is not capable of receiving the ultrasound whose intensity is equivalent to a voltage of less than 20 mV in the graph shown in FIG. 6.

In a case when the conventional ultrasonic electronic stylus is used, a maximum distance that can be measured by such a low-sensitive ultrasound receiving device is 30 mm (dotted line in FIG. 6).

However, in a case when the ultrasonic electronic stylus 1b of the present embodiment is used, the same ultrasound receiving device can sensitively measure the position of the ultrasonic electronic stylus 1b even when the ultrasonic electronic stylus 1b is 200 mm away from the ultrasound receiving device.

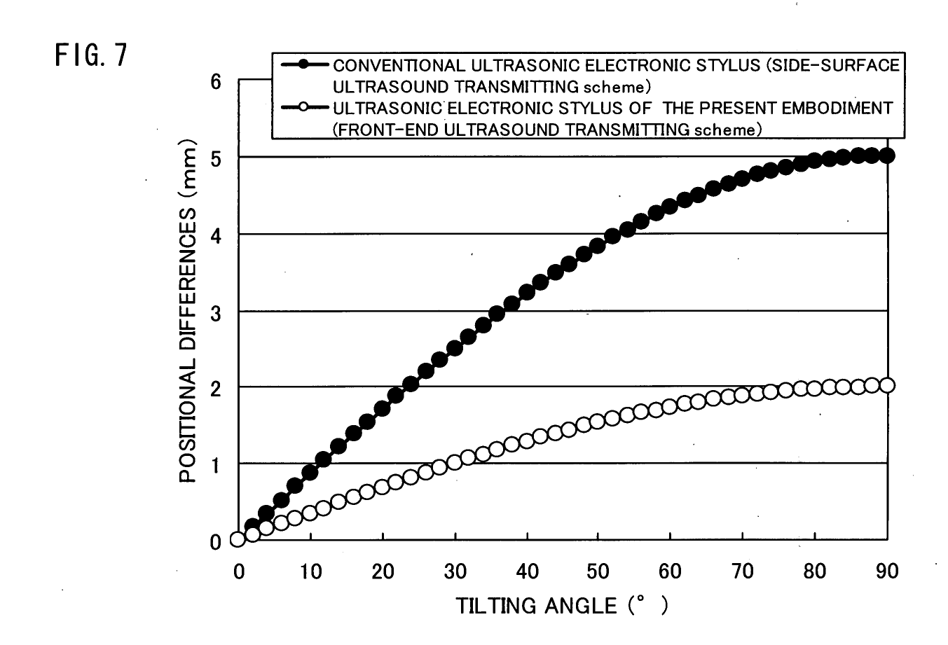

Next, comparison on positional differences are made between the ultrasonic electronic stylus 1b of the present invention adopting the front-end ultrasound emitting method and the conventional ultrasonic electronic stylus adopting the side-surface ultrasound emitting method. More specifically, comparison is made on differences between a position of the front end of the ultrasonic electronic stylus being tilted and a position determined based on positional information of the ultrasonic electronic stylus obtained by the ultrasound receiving device. FIG. 7 is a graph showing differences in position with respect to a tilting angle of the ultrasonic electronic stylus. As shown in FIG. 7, when compared with the conventional ultrasonic electronic stylus of the side-face ultrasound emitting type, the ultrasonic electronic stylus 1b has a smaller positional difference with respect to a tilting angle of the stylus. This is because the ultrasonic electronic stylus 1b is a front-end ultrasound transmitting type ultrasonic electronic stylus.

The ultrasonic electronic stylus 1b of the present embodiment adopts the enclosure 13 of 9 mm in diameter, 120 mm in length, 10 g in weight. The weight and shape of the ultrasonic electronic stylus 1b adopting this enclosure 13 is appropriate for actual use. It should be noted that the enclosure 13 of approximately 5 g in weight is strong enough to be used as an enclosure, though it depends on which material is used for the enclosure 13.

The following deals with a stylus-input system of the present invention, in which the ultrasonic electronic stylus is utilized.

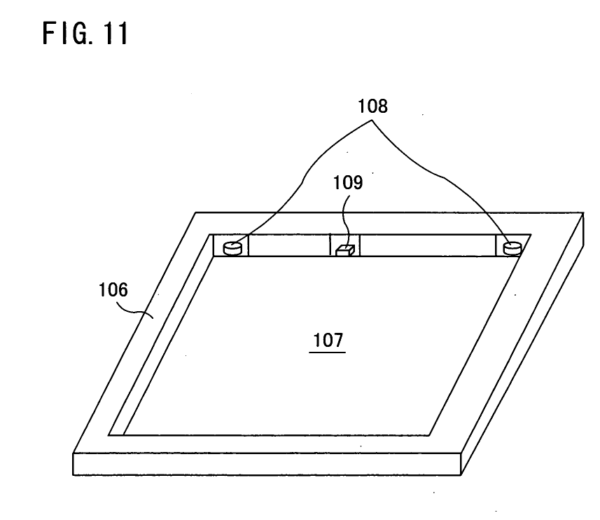

In the stylus-input system in accordance with the present embodiment, a tablet PC (receiving means) and the ultrasonic electronic stylus are provided. Further, the tablet PC is provided with the ultrasound receiving device having an ultrasound receiving element 108. FIG. 11 is a diagram of a main part of the stylus-input system according to the present invention, in which the ultrasonic electronic stylus is used. In FIG. 11, a display section 107 of the tablet PC and periphery of the display section 107 are shown.

In the stylus-input system of the present embodiment, a frame 106 serving as an enclosure of the tablet PC main body is provided with the ultrasound receiving element 108 in an inner side surface of the frame 106 where there is a gap in a level of the frame 106 and a level of the display section 107. More specifically, a hole is provided in part of the frame 106, and the ultrasound receiving element 108 is so provided that at least part of the ultrasound receiving element 108 is exposed out of the hole. The ultrasound receiving element 108 receives ultrasound from an ultrasonic electronic stylus (not shown). The ultrasound receiving element 108 may be provided at any positions as long as reception of the ultrasound from the ultrasonic electronic stylus is not blocked by a hand of a person who inputs. For example, it is preferable to provide the ultrasound receiving element 108 at both ends (i.e. in two positions) of a side opposite to the side where the person who inputs is (a side farthest from the side where the person who inputs is).

Further, the ultrasonic electronic stylus of the present invention may transmit infrared light as input-start signal in addition to ultrasound. In this case, the ultrasonic electronic stylus is provided with an infrared light transmitting section, and transmits the ultrasound and the infrared light from the front end of the ultrasonic electronic stylus. Further, the tablet PC is provided with the infrared light receiving device having the infrared light receiving element 109. The infrared light receiving element 109 may be provided to the frame 106, at a position midway between the two ultrasound receiving elements 108 in the same manner as the ultrasound receiving element 108.

In this case, the positional information of the ultrasonic electronic stylus is obtained as follows. Namely, the positional information of the ultrasonic electronic stylus is calculated out, in an calculating section of the tablet PC, from (i) a difference between a timings of the ultrasound receiving element 108 receiving the ultrasound and a timing of the infrared light receiving section 109 receiving the infrared light, i.e. the input start signal, and (ii) frequency the ultrasound. Since the ultrasound receiving element 108 is provided at two positions, two pieces of positional information are calculated out. The position of the ultrasonic electronic stylus is determined based on these two pieces of the positional information.

As described, the ultrasonic electronic stylus of the present invention is for use in the stylus-input system. More specifically, as described, the stylus-input system (i) measures the tool force by using the tool force measuring mechanism in the ultrasonic electronic stylus, and (ii) determines the position of the ultrasonic electronic stylus by receiving the ultrasound transmitted from the ultrasonic electronic stylus. With this stylus-input system, it is possible to process information, such as a character or an image, inputted by the ultrasonic electronic stylus into electronic data accurately reflecting such information. It should be noted that, in the stylus-input system, it is possible to process, into electronic data, (i) information directly drawn/written on a electronic display by using the ultrasound electronic stylus, or (ii) information drawn/written on a piece of paper or a board specialized for the stylus-input system.

As described, it is preferable that the ultrasonic electronic stylus of the present invention be such that the ultrasound is generated by the ultrasound element, and transmitted from the front end of the ultrasonic electronic stylus.

In a case where the ultrasonic electronic stylus is tilted while being used, there is a difference between an actual position of the writing-tip and the position determined based on the positional information obtained from the ultrasound. In the foregoing arrangement, the ultrasound is transmitted from a vicinity of the front end of the ultrasonic electronic stylus. This causes the difference between the actual position of the writing-tip and the position determined based on the position information to be smaller than a case where the ultrasound is transmitted from the side surface of the ultrasonic electronic stylus. Thus, it is possible to accurately measure the position of the ultrasonic electronic stylus by using the ultrasound.

Further, the tool force measuring means in the ultrasonic electronic stylus of the present invention includes a magnet, and a magnetoresistive element whose electric resistance varies in accordance with a change in magnetic field of the magnet, and the magnet and the magnetoresistive element are provided such that a distance between the magnet and the magnetoresistive element varies in accordance with the tool force applied.

With this arrangement, the distance between the magnet and the MR element varies in accordance with the tool force, and intensity of the magnetic field applied from the magnet to the MR element also varies accordingly. Therefore, it is possible to measure the tool force by measuring the magnetic field applied to the MR element.

Further, it is preferable that the ultrasonic electronic stylus of the present invention be provided with the expanding-and-contracting means which contracts and expands in accordance with changes in the distance between the magnet and the MR element.

With this arrangement, the expanding-and-contracting means contracts and expands in accordance with the tool force, realizing input operation similar to input operation using an actual pen.

It is further preferable that the ultrasonic electronic stylus of the present invention be provided with the contact preventing means for preventing the magnet and the MR element from coming into contact with each other.

With this arrangement, since the contact preventing means prevents the magnet and the MR element from coming into contact with each other, contact-caused damages on the magnet and the MR element are prevented.

The ultrasound element is preferably the piezoelectric element made of lead zirconate titanate.

With this ultrasound element, the ultrasound is efficiently emitted from the ultrasound element.

As described, a stylus-input system in accordance with the present invention includes an ultrasonic electronic stylus having at least (i) An ultrasonic electronic stylus including at least (a) an ultrasound element for generating ultrasound; (b) tool force measuring means for measuring a tool force applied in stylus input operation; and (c) control means for controlling the ultrasound element and the tool force measuring means, the ultrasound element, the tool force measuring means, and the control means being arranged in this order from a side of a front end of the ultrasonic electronic stylus where pen input is carried out, toward a side of a rear end thereof; and (ii) receiving means for receiving the ultrasound transmitted from the ultrasound electronic stylus.

With this arrangement, the ultrasound is efficiently transmitted from the ultrasonic electronic stylus, and a position of the ultrasonic electronic stylus is accurately determined. Therefore, it is possible to provide the stylus-input system which is capable of processing information inputted by the ultrasonic electronic stylus into electronic data accurately reflecting such information.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. An ultrasonic electronic stylus comprising:
(a) an ultrasound element for generating ultrasound;
(b) tool force measuring means for measuring a tool force applied in stylus input operation; and
(c) control means for controlling the ultrasound element and the tool force measuring means,
the ultrasound element, the tool force measuring means, and the control means being arranged in this order from a side of a front end of the ultrasonic electronic stylus where stylus input is carried out, toward a side of a rear end thereof.

2. The ultrasonic electronic stylus as set forth in claim 1, wherein:
the ultrasound generated by the ultrasound element is transmitted from the front end.

3. The ultrasonic electronic stylus as set forth in claim 1, wherein:
the tool force measuring means includes a magnet, and a magnetoresistive element whose electric resistance varies in accordance with a change in magnetic field of the magnet; and
the magnet and the magnetoresistive element are provided such that a distance between the magnet and the magnetoresistive element varies in accordance with the tool force applied.

4. The ultrasonic electronic stylus as set forth in claim 3, comprising:
expanding-and-contracting means which expands and contracts in accordance with a change in the distance between the magnet and the magnetoresistive element.

5. The ultrasonic electronic stylus as set forth in claim 3, comprising:
contact preventing means for preventing the magnet and the magnetoresistive element from coming into contact with each other.

6. The ultrasonic electronic stylus as set forth in claim 1, wherein:
the ultrasound element is a piezoelectric element formed of lead zirconate titanate.

7. The ultrasonic electronic stylus as set forth in claim 1, comprising:
an infrared light transmitting section for transmitting infrared light from the front end.

8. An ultrasonic electronic stylus comprising:
an enclosure including:
(a) an ultrasound element for generating ultrasound, the ultrasound element moving in the enclosure in accordance with a tool force applied in stylus input operation;
(b) tool force measuring means having at least a magnet and a magnetoresistive element whose electric resistance varies in accordance with a change in magnetic field of the magnet, the magnet or the magnetoresistive element being fixed to the ultrasound element; and
(c) control means for controlling the ultrasound element and the tool force measuring means,
the ultrasound element, the tool force measuring means, and the control means being arranged in this order from a front-end side of the enclosure toward a rear-end side of the enclosure.

9. The ultrasonic electronic stylus as set forth in claim 8, comprising:
a supporting rod for fixing the magnet or the magnetoresistive element to the ultrasound element, the supporting rod being movable within the enclosure in a state of being held by supporting members.

10. The ultrasonic electronic stylus as set forth in claim 8, comprising:
expanding-and-contracting means which expands and contracts in accordance with a change in the distance between the magnet and the magnetoresistive element.

11. The ultrasonic electronic stylus as set forth in claim 8, comprising:
contact preventing means for preventing the magnet and the magnetoresistive element from coming into contact with each other.

12. The ultrasonic electronic stylus as set forth in claim 8, comprising:
the ultrasound generated by the ultrasound element is transmitted from the front end.

13. The ultrasonic electronic stylus as set forth in claim 8, wherein:
the ultrasound element is a piezoelectric element formed of lead zirconate titanate.

14. The ultrasonic electronic stylus as set forth in claim 8, comprising:
an infrared light transmitting section for transmitting infrared light from the front end.

15. A stylus-input system comprising:
(i) An ultrasonic electronic stylus including at least:
(a) an ultrasound element for generating ultrasound;
(b) tool force measuring means for measuring a tool force applied in stylus input operation; and
(c) control means for controlling the ultrasound element and the tool force measuring means,
the ultrasound element, the tool force measuring means, and the control means being arranged in this order from a side of a front end of the ultrasonic electronic stylus where pen input is carried out, toward a side of a rear end thereof; and
(ii) receiving means for receiving the ultrasound transmitted from the ultrasound electronic stylus.

16. The stylus-input system as set forth in claim 15, wherein:
the ultrasonic electronic stylus further includes an infrared light transmitting section for transmitting infrared light from the front end; and
the receiving means receives the infrared light transmitted from the ultrasonic electronic stylus.

17. A stylus-input system comprising:
(i) an ultrasonic electronic stylus having an enclosure including:
(a) an ultrasound element for generating ultrasound, the ultrasound element moving in the enclosure in accordance with a tool force applied in stylus input operation;
(b) tool force measuring means having at least a magnet and a magnetoresistive element whose electric resistance varies in accordance with a change in magnetic field of the magnet, the magnet or the magnetoresistive element being fixed to the ultrasound element; and
(c) control means for controlling the ultrasound element and the tool force measuring means,
the ultrasound element, the tool force measuring means, and the control means being arranged in this order from a front-end side of the enclosure toward a rear-end side of the enclosure; and
(ii) receiving means for receiving the ultrasound transmitted from the ultrasound electronic stylus.

18. The stylus-input system as set forth in claim 17, wherein:
the ultrasonic electronic stylus further includes an infrared light transmitting section for transmitting infrared light; and
the receiving means receives the infrared light transmitted from the ultrasonic electronic stylus.
